(19) United States
(12) Patent Application Publication
(10) Pub. No.: US 2012/0241538 A1
(43) Pub. Date: Sep. 27, 2012

(54) PERCUSSIVE SPRINKLER WITH ADJUSTABLE BALANCING WEIGHTS

(76) Inventor: Cheng-An WANG, Lu Kang Town (TW)

(21) Appl. No.: 13/069,606

(22) Filed: Mar. 23, 2011

(51) Int. Cl. B05B 3/00

(52) U.S. Cl. 239/230

(57) ABSTRACT

A percussive sprinkler having adjustable balancing weights. The percussive sprinkler has a main body and a diversion member. The percussive sprinkler is mainly characterized in that a guiding section is formed onto the swinging portion of the diversion member, and also sleeved with an adjustable balancing weight. The balancing weight includes a weight stack and an adjuster. Moreover, the adjustable balancing weight can slide axially along the guiding section via the help of the adjuster, so the swinging portion is available with different swinging angles. With this innovative construction, the percussive sprinkler of the present invention has improved operational convenience and adaptability with better applicability and industrial benefits.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC Not applicable.

### BACKGROUND OF THE INVENTION

1. Field of the Invention

The present invention relates generally to a percussive sprinkler, and more particularly to an innovative one which has adjustable balancing weights.

2. Description of Related Art Including Information Disclosed Under 37 CFR 1.97 and 37 CFR 1.98.

The percussive sprinkler is generally used in gardening applications for sprinkling and irrigation, since circulatory or reciprocating sprinkling can be implemented with the percussive sprinkler in an annular range.

In order to maintain a proper amount of water for sprinkling purpose, the percussive sprinkler is designed in such a way that a balancing weight is installed at one end of the diversion member to change its swinging angle, enabling appropriate water supply from the percussive sprinkler depending on the weather conditions.

However, as the balancing weight is fixed securely at a preset location of the diversion member, the percussive sprinkler with different balancing weights has to be replaced if it is intended to change the swinging angle of the diversion member. So, a variety of percussive sprinklers must be be fabricated, leading to higher production cost and also time-consuming replacement.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

The “percussive sprinkler with adjustable balancing weights” of the present invention is mainly characterized by that, said guiding section is formed on either the rear or front section of the swinging portion, and also sleeved with an adjustable balancing weight for axial sliding. With this innovative construction, the percussive sprinkler of the present invention permits one to change easily the swinging angle of the swinging portion through the sliding of the adjustable balancing weight, such that flexible irrigation by the percussive sprinkler can be realized to meet diversified irrigation demands in various operating environments, further improving the operational convenience and adaptability with better applicability and industrial benefits.

### BRIEF DESCRIPTION OF THE SEVERAL VIEWS OF THE DRAWINGS

FIG. 1 is a front plan view of the percussive sprinkler of the present invention.

FIG. 2 is a plan view of the present invention wherein the percussive sprinkler's balancing weight can be adjusted.

FIG. 3 is a sectional view of the present invention wherein the balancing weight can be limited.

FIG. 4 is a sectional view of the present invention wherein the balancing weight can be adjusted.

FIG. 5 is a perspective view of the present invention wherein the balancing weight can be adjusted.

FIG. 6 is a schematic view of another preferred embodiment of the adjuster of the present invention.

FIG. 7 is a schematic view of another preferred embodiment of the balancing weight of the present invention.

FIG. 8 is a schematic view of the present invention wherein a balancing weight stopper is set at one end of the guiding section.

### DETAILED DESCRIPTION OF THE INVENTION

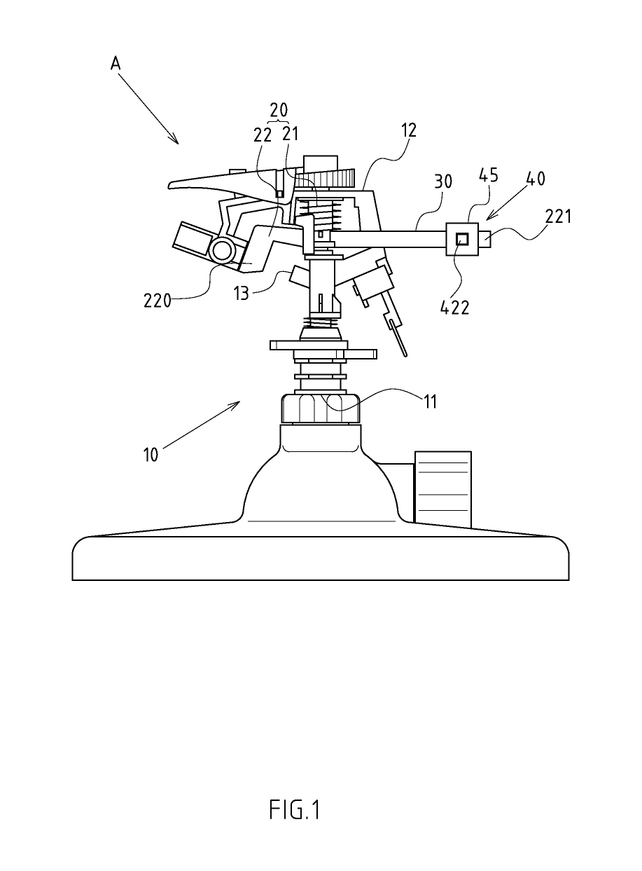

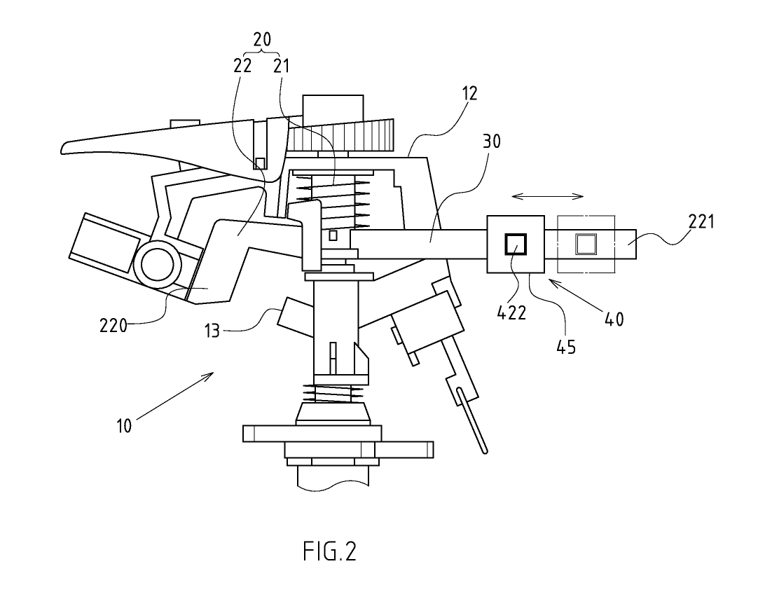

FIGS. 1-2 depict preferred embodiments of a percussive sprinkler of the present invention with adjustable balancing weights, which, however, are provided for only explanatory objective for patent claims.

Said percussive sprinkler A includes a main body 10, at lower end of which an inlet tube coupling end 11 is set, and at upper end of which a top section 12 is set. A water outlet 13 is located close to the lower flange of the top section 12. The top section 12 of the preferred embodiment is configured into a framework, but not limited to this pattern.

A diversion member 20 is arranged onto the top section 12 at upper end of the main body 10, and comprises of a torsional spring 21 and a swinging portion 22. A front section 220 and a rear section 221 are defined on the swinging portion 22.

A guiding section 30 is formed onto either of the rear section 221 or front section 220 of the swinging portion 22.

An adjustable balancing weight 40 is sleeved externally onto the guiding section 30, and comprises of a weight stack 45 and an adjuster 41. The adjustable balancing weight 40 can slide axially along the guiding section 30 via the help of the adjuster 41. The swinging portion 22 is available with different swinging angles.

Of which, the balancing weight can be represented in multiple patterns.

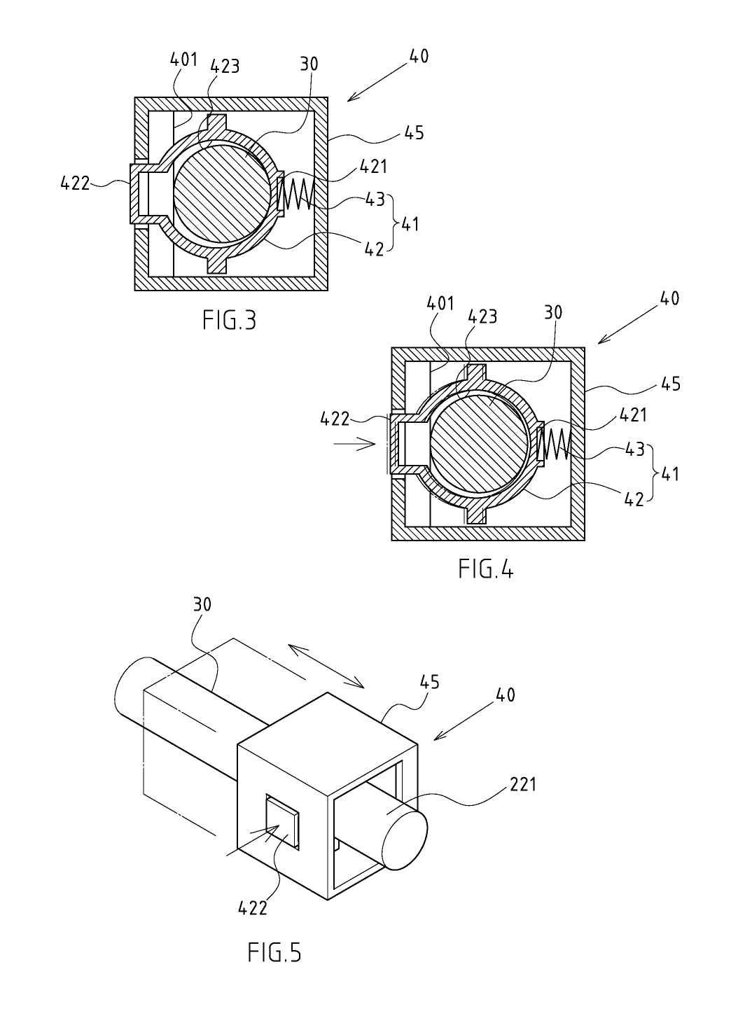

Referring to FIGS. 3, 4 and 5, said balancing weight 40 is configured into a framework, where a limiting side 401 is formed laterally. The adjuster 41 is set within the balancing weight 40, and comprises of an elastic part 43 and an extruded seat 42. An extension 423 is formed within the extruded seat 42 for penetration of the guiding section 30. An abutting surface 421 and a push type release portion 422 are formed separately at both sides of the extruded seat 42. The abutting surface 421 is located correspondingly with a spacing to the limiting side 401, and the elastic part 43 is assembled laterally onto the abutting surface 421 and the balancing weight 40, such that the guiding section 30 can be spaced between the limiting side 401 and abutting surface 421 for a limited sliding (as shown in FIG. 3). When the push type release portion 422 is pressed, said extruded seat 42 moves towards the elastic part 43, so the limiting state of the guiding section 30 is released to control the sliding of the balancing weight 40.

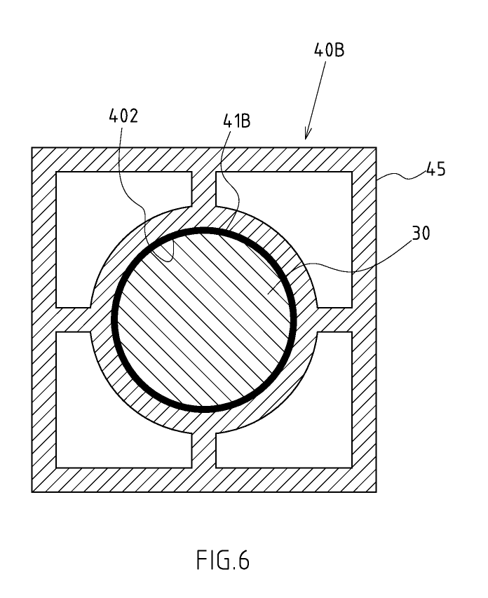

Referring to FIG. 6, said balancing weight 40B is configured into a framework wherein a sleeving portion 402 is mated with the guiding section 30 for insertion of the guiding section 30. The adjuster 41B is of a rubber pad connected to the inner side of the sleeving portion 402, and also located between the exterior of the guiding section 30 and the sleeving portion 402.

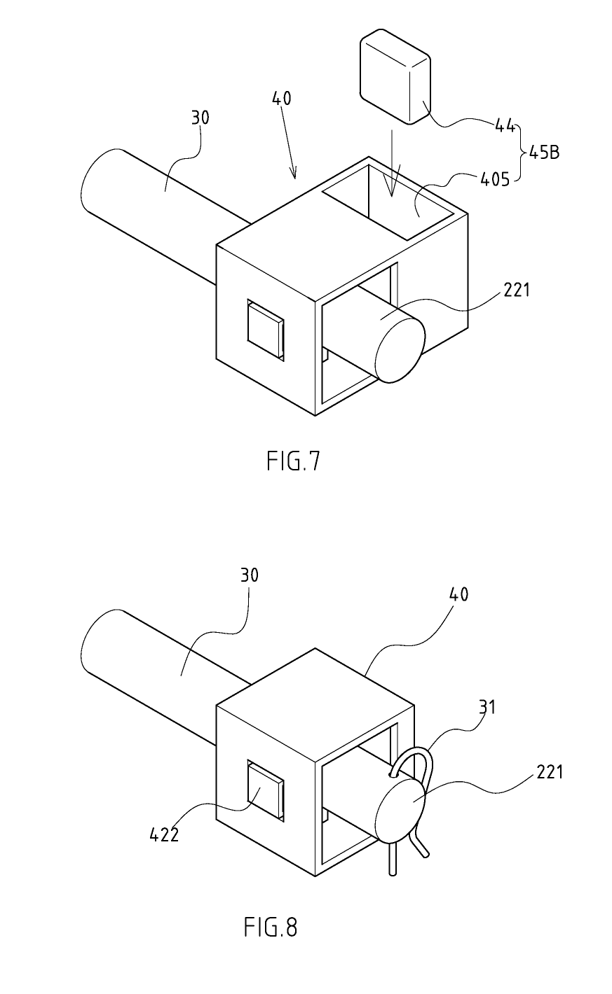

Of which, said weight stack 45 can be represented in multiple patterns. Referring to FIG. 1, said weight stack 45 is prefabricated by the balancing weight 40, or referring to FIG. 7, said weight stack 45B allows to set a holding tank 405 externally onto the balancing weight 40 to accommodate the balancing weight 44. Moreover, said weight stack of the balancing weight allows one to set a holding portion at one side of the balancing weight for inputting metal solution (not marked in the figure). The metal solution refers to a lead solution.

Referring to FIG. 8, a balancing weight stopper 31 is set at one end of the guiding section 30 to avoid disengagement of the balancing weight 40.

Based on above-specified structural configuration, the core of the percussive sprinkler of the present invention lies in that, said guiding section 30 is formed onto either of the rear section 221 or front section 220 of the swinging portion 22; and also sleeved with an adjustable balancing weight 40. Said balancing weight 40 can slide axially along the guiding section 30 (in collaboration with FIG. 2). In the preferred embodiment, the guiding section 30 is formed onto the rear section 221 of the swinging portion 22. When the balancing weight 40 slides axially close to the end of the guiding section 30 through the adjuster 41, the swinging angle of the swinging portion 22 is larger as the case may be when the balancing weight 40 is far away from the end of the guiding section 30, helping to change the density of sprinkling So, the user can allow for irrigation depending on the residual water quantity. For instance, after rainy weather, the user can move the balancing weight 40 far away from the end of the guiding section 30, the swinging angle of the swinging portion 22 becomes smaller to reduce the irrigation time and prevent excessive water from damage of the plant roots. In the present invention, said balancing weight 40 slides close to the end of the guiding section 30, such that the swinging angle of the swinging portion 22 becomes larger to increase irrigation time. Hence, the percussive sprinkler enables appropriate irrigation in response to the weather conditions.

1. A percussive sprinkler with adjustable balancing weight comprising:
a main body, at lower end of which an inlet tube coupling end is set, and at upper end of which a top section is set; and a water outlet is located close to the lower flange of the top section;
a diversion member; arranged onto the top section at upper end of the main body, and comprising of a torsional spring and a swinging portion; a front and rear section are defined on the swinging portion;
a guiding section; formed onto either of the rear or front section of the swinging portion;
an adjustable balancing weight; sleeved externally onto the guiding section, and comprising of a weight stack and an adjuster; the adjustable balancing weight can slide axially along the guiding section via the help of the adjuster; the swinging portion is available with different swinging angles.

2. The structure defined in claim 1, wherein said balancing weight is configured into a framework, where a limiting side is formed laterally; the adjuster is set within the balancing weight, and comprises of an elastic part and an extruded seat; an extension is formed within the extruded seat for penetration of the guiding section; an abutting surface and a push type release portion is formed separately at both sides of the extruded seat; the abutting surface is located correspondingly with a spacing to the limiting side, and the elastic part is assembled laterally onto the abutting surface and the balancing weight, such that the guiding section can be spaced between the limiting side and abutting surface for a limited sliding; when the push type release portion is pressed, said extruded seat moves towards the elastic part, so the limiting state of the guiding section is released to control the sliding of the balancing weight.

3. The structure defined in claim 1, wherein said balancing weight is configured into a framework wherein a sleeving portion is mated with the guiding section for insertion of the guiding section; and the adjuster is of a rubber pad connected to the inner side of the sleeving portion, and also located between the exterior of the guiding section and the sleeving portion.

4. The structure defined in claim 1, wherein a balancing weight stopper is set at one end of the guiding section.

5. The structure defined in claim 1, wherein said weight stack is prefabricated by the balancing weight.

6. The structure defined in claim 1, wherein said weight stack of the balancing weight allows for setting a holding portion at one side of the balancing weight for inputting metal solution.

7. The structure defined in claim 1, wherein said weight stack allows for setting a holding tank externally onto the balancing weight to accommodate the balancing weight.
